(19) United States
(12) Patent Application Publication
(10) Pub. No.: US 2023/0384224 A1
(43) Pub. Date: Nov. 30, 2023

(54) METHODS AND APPARATUS FOR LIGHT-MICROSCOPIC MULTICSCALE RECORDING OF BIOLOGICAL SPECIMENS

(71) Applicant: ABBERIOR INSTRUMENTS GMBH, Gottingen (DE)

(72) Inventors: Gerald DONNERT, Gottingen (DE); Benjamin HARKE, Gottingen (DE); Winfried WILLEMER, Bovenden (DE)

(21) Appl. No.: 18/031,823

(22) PCT Filed: Oct. 15, 2021
(86) PCT No.: PCT/EP2021/078654

§ 371 Date: Apr. 13, 2023

(30) Foreign Application Priority Data
Oct. 16, 2020 (DE) 10 2020 127 385.1

(51) Int. Cl. G01N 21/64; G02B 21/00

(52) U.S. Cl. CPC G01N 21/6458; G01N 21/6428; G02B 21/008; G01N 2021/6441; G01N 2021/6421

(57) ABSTRACT

Methods and a device for imaging a sample stained with multiple dyes are disclosed. The methods enable nanoscopic imaging with up to molecular resolution to be placed in the spatial context of microscopic images, or nanoscopic tracking of individual molecules to be performed in the spatial context of a microscopic image. The methods combine different light-optical microscopy techniques in a particularly efficient manner. Molecular resolution can be achieved by a localization microscopic method, in particular by localization according to a MINFLUX or STED-MINFLUX method. These methods are characterized by the fact that, on the one hand, they are particularly gentle on the sample during the steps that precede imaging with molecular resolution, and on the other hand, they make optimal use of the fluorescence photons during localization or enable optimal use.

### TECHNICAL FIELD OF THE INVENTION

The invention relates to methods of optical microscopy, in particular to methods of super-resolved, non-diffraction-limited fluorescence optical microscopy of biological samples. It also refers to combination methods in which non-diffraction-limited fluorescence optical microscopy methods form a component. Further, it also relates to method combinations with method components that are light-optical but not fluorescence microscopic, as well as those with method components that are not light-optical. Further, the invention relates to corresponding devices.

### PRIOR ART

From the German patent specification DE 10 2018 126 232 B3, a scanning microscope is known that comprises several light sources. The light sources can be narrow-band lasers or white-light lasers. The light sources are each coupled individually or jointly in each case by means of a dichroic mirror into a common illumination beam path. The coupling takes place in a section through which detection light passes in the opposite direction. The set of different light sources may be provided for different purposes; for example, the individual light sources of the set may provide excitation light for confocal microscopy imaging, imaging by MINFLUX nanoscopy, or imaging by STED microscopy of different dyes. A light source can also serve as a light source for fluorescence inhibition light, especially STED light. In this case, the microscope would also need to comprise a beam shaping device that adjusts the wavefront of the illumination light so that an intensity zero of fluorescence inhibition light surrounded by intensity maxima is formed at the focal point of the objective. A corresponding beam shaping device would also have to be present in MINFLUX nanoscopy. The patent is directed to an exchange device by means of which a dichroic mirror associated with a light source is exchanged for a plane-parallel plate which imprints the same parallel offset on the beam path as the dichroic mirror when the light source in question is not required for illumination. This ensures, on the one hand, that light emitted from the sample at the wavelength of the light source not required can also be detected and, on the other hand, that the alignment of the beam paths with respect to each other is maintained. The scanning microscope further comprises an objective through which the illumination light is focused on a sample, and a scanner which shifts the light intensity distribution of the illumination light with respect to the sample and descans the detection light. Further, it comprises in the detection beam path an adjustable wavelength-selective bandpass filter composed of an adjustable short-pass filter and an adjustable long-pass filter. The light passing through the filter is fed to a detector through a detection light output, while the reflected light is fed to another output. The reflected light can then be fed to another adjustable wavelength-selective bandpass filter, meaning the filters can be cascaded. The filter is described as being able to analyze the spectrum of the detection light by continuously tuning the filter.

From the German patent application publication DE 10 2010 015 915 A1 a method for the determination of excitation spectra and emission spectra of fluorescent dyes in a sample is known, which is carried out by means of a microscope. The microscope is equipped with a plurality of detectors, wherein the detectors alternately detect light of different wavelength bands. All wavelength bands can be spectrally shifted, but even after shifting, the detectors mutually detect light of different wavelength bands. Further, the microscope comprises a laser whose emission wavelength can be spectrally shifted. For the determination of the excitation spectrum, a first excitation of the sample with a first wavelength takes place and the fluorescence is measured with the plurality of detectors which are in a first setting with respect to the spectral detection bands, subsequently a shift of the excitation wavelength takes place, again the resulting fluorescence is measured with the plurality of detectors in the first setting; this is repeated several times if necessary; in the specifically shown embodiment, the excitation takes place successively with a total of five excitation wavelengths and the detection with five detectors. This sequence forms a first run of excitation steps. In this run, (five) first grid points of the excitation spectrum are obtained by determining the sum of the individual detector signals for each excitation wavelength. At the same time, for each of the (five) excitation wavelengths, an emission spectrum with several (five) supporting points is obtained; according to the disclosure, information would be obtained that could be used to determine the emission spectrum. According to a graphical representation of the relationship of the excitation wavelengths and the detection bands, in the first pass, the detection band of a first detector starts just above the first excitation wavelength, that of the second detector starts just above the second excitation wavelength, and so on. Subsequently, a second pass is performed accordingly, wherein on the one hand the detection wavelength bands of all detectors are shifted by an amount and on the other hand the excitation wavelengths are shifted by the same amount. The wavelength band of the longest wavelength detector thereby becomes narrower according to the graphical representation, since the lower threshold wavelength of the detection range is changed, but not the upper one. In this second pass, (five) further supporting points of the excitation spectrum are obtained. Corresponding further passes with further shifted excitation wavelengths and detection wavelength bands can now be made. The shifting takes place exactly until, in the case of a further shift, the first excitation wavelength of the following run would correspond to the second excitation wavelength of the first run. This means each individual excitation wavelength is used with exactly one adjustment of the spectral wavelength bands of the detectors. Preferably, the passes can and should occur during the scanning imaging of the sample. Preferably, the scanning of the sample and the imaging of the sample are described to be done just in such a way that just with the complete imaging of the spectra there is also a complete image of the sample. The document further states that for each of the excitation wavelengths an emission spectrum is obtained from the signals of the individual detectors, in the mentioned embodiment example one with five supporting points. The number of supporting points could be increased by increasing the number of individual detectors. It is further claimed that dyes with identical emission spectra might be distinguished on the basis of different excitation spectra, which would make it possible to image the dyes individually in a multiply stained sample. A closer look, however, shows that the method specifically given as the only embodiment is flawed and that the statements on the application to multicolored samples do not apply. This is because the shifting of the lower limit wavelength of the detection range with the shifting of the excitation wavelengths from run to run changes the detected wavelength range from run to run, it becomes smaller, so that the values obtained in the second run will be systematically and erroneously proportionally too small compared to the values obtained in the first run. If several dyes are present in the sample, regardless of the problem described above, it is simply impossible to determine the excitation spectrum of a single one of the dyes. This is because several dyes are excited during excitation, and the detectors therefore always detect a sum signal. However, a decomposition of the sum signal into its individual summands is only possible if the excitation spectra of the individual dyes are known. If this were the case, then the ratios in which the dyes are present in the excitation range could be determined. In fact, however, the excitation spectrum is to be determined first according to the procedure.

Microscopes, in particular confocal laser scanning microscopes with detection units whose spectral sensitivity range can be adjusted, have been mentioned many times in the prior art. As an example, the German patent application publication DE 10 2006 034 908 A1 is mentioned. The detection wavelengths are regularly adjusted as a function of the fluorophores present in the respective sample. The adjustability of the filters then serves to ensure that only an adjustment of components, but no exchange, has to take place before the start of image acquisition on a sample.

A still young microscopy method is MINFLUX nanoscopy. MINFLUX nanoscopy is a localization microscopy method. The localization of fluorophores is performed by means of structured excitation light distributions. A fundamental feature of MINFLUX nanoscopy is that the excitation of the fluorophores is performed in such a way that a fluorophore to be localized is always placed close to or in a minimum of the excitation light distribution, which is ideally a zero, wherein the excitation light distribution adjacent to the minimum comprises an intensity increase range. This provides a better utilization of the fluorescence photons with respect to obtaining information about the position of the respective emitting fluorophore. This also applies to applications in which the movement of fluorophores is to be tracked over time. The observation of a sample using an excitation minimum, the basis of MINFLUX nanoscopy, is known from the patents DE 10 2011 055 367 B4, here initially only for tracking the movement of individual molecules in a sample, and DE 10 2013 114 860 B3. DE 10 2011 055 367 B4 also addresses the possibility of tracking two different fluorophores simultaneously. For this purpose, two different light sources are to be used, which are switched between in rapid alternation.

Based on this, a number of refinements for information retrieval have been developed, which allow localization of fluorophores with an uncertainty in the range below 2 nm. This quantity of uncertainty corresponds to the extent of fluorophores. A detailed account of MINFLUX nanoscopy can be found in “Nanometer resolution imaging and tracking of fluorescent molecules with minimal photon fluxes,” Francisco Balzarotti et. al, arXiv:1611.03401 [physics.optics] (2016). Basically, in order to localize a fluorophore using MINFLUX nanoscopy, the intensity minimum or zero must be placed at a plurality of positions relative to the location of the fluorophore. For this, a position of the fluorophore has to be estimated with a first, lower accuracy in a preparatory step. This can be done, for example, by means of ordinary localization microscopy (PALM, STORM) or by means of other known methods. For this purpose, the publication mentioned describes a method in which a sample is scanned with a Gaussian intensity distribution until fluorescence is detected at a scanning position, which with some probability originates from a isolated molecule. The scanning is then stopped and the intensity distribution is then positioned around the scanning position at several locations, specifically four locations, at a distance of less than the wavelength of light from the scanning position. From the photon counts measured at each position, the position of the isolated emitter is estimated according to a procedure described in the publication. The estimation corresponds in essence to a ratiometric evaluation of the photon numbers. Subsequently, an intensity distribution of excitation light with a central minimum, for example in the shape of a donut as known from STED microscopy, is placed at a known position chosen such that the fluorophore is close to the minimum of the intensity distribution. The fluorescence response of the fluorophore is measured. The same is repeated for one or more other positions of the intensity distribution. By means of a ratiometric evaluation of the intensity ratios, the position of the fluorophore is determined with higher accuracy. Basically, the emission rate increases the further the fluorophore is from the excitation minimum or the further the fluorophore is shifted into an intensity increase region. This more accurately determined position can now be used as a starting position for repeating the sequence of steps above, with the plurality of positions closer to the estimated fluorophore position. Particularly with respect to tracking the movement of fluorophores, the change in emission rate as the fluorophore moves into the intensity rise region or toward the minimum can also be used to estimate the displacement of the fluorophore with high accuracy. The closer the minimum positions of the intensity distribution are to the actual location of the fluorophore in each case, the fewer fluorescence photons are required for localization with a given uncertainty or accuracy. The MINFLUX method can also be used for localization in three dimensions, for example, using so-called bottle beams for excitation.

In particular, the patent specifications for MINFLUX nanoscopy are WO 2018/069 283 A1, US 2019/0235220 A1, US 2019/0234882 A1 and US 2019/0234879 A1, wherein the aforementioned US patent applications are all follow-on applications to the first-mentioned provisional international patent application, in which all the concepts mentioned subsequently with reference to the US disclosure specifications are also disclosed. In all the writings, it is mentioned that a STED microscope can be used to perform the MINFLUX method, wherein the light, which is fluorescence inhibition light when used as a STED microscope, is used as excitation light.

US 2019/0235220 A1 is directed to a method having a small or minimal number of positions at which an intensity minimum adjacent to both sides of intensity increasing regions in each spatial direction in which a location of the fluorophore is to be determined is placed to determine the location of the fluorophore.

US 2019/0234882 A1 is directed to the method described further above, in which the location information obtained from a first MINFLUX step is used to place the minimum of the intensity light distribution closer to the fluorophore in each case in a subsequent step and derive more precise location information therefrom.

US 2019/0234879 A1 is directed to a method in which the intensity minimum is placed very quickly, quasi-simultaneously, at a plurality of positions around the estimated location of the fluorophore. A single position is then moved closer to the suspected minimum if an increased emission rate is detected at it.

The publication “MINFLUX nanoscopy delivers 3D multicolor nanometer resolution in cells,” Klaus C. Gwosch et. al, Nat Methods 17, 217-224 (2020), https://doi.org/10.1038/s41592-019-0688-0, is directed at three-dimensional nanoscopy with several different fluorophores. The publication also documents evidence that by means of iteratively approximating the minimum positions to the actual location of the fluorophore in question, a reduction in the uncertainty of localization is achieved compared to ratiometric localization with fixed minimum positions. It is further shown that isotropic resolution in three dimensions is achieved in this way. For imaging using different fluorophores, dyes are used in each case that mutually exhibit a large overlap of spectral absorption curves and thus can be excited with one and the same excitation wavelength. Specifically illustrated is three-dimensional nanoscopy with two different fluorophores each, using a total of two different pairs (A: CF660C and Alexa Fluor 647; B: CF680C and Alexa Fluor 647), with one partner of the pair being the Alexa Fluor 647 dye in both pairs. In MINFLUX imaging, the same laser is used to excite both dyes of a pair. The two dyes of each pair differ in their emission characteristics. The detection path of the nanoscopy arrangement used is divided by means of a dichroic beam splitter into a spectral detection channel for light of a wavelength above 685 nm and one for light of a wavelength below 685 nm. When the measurement is carried out, since the spectral emission of all fluorophores used is clearly not equal to 0 (zero) both above and below the threshold wavelength, light is detected in both spectral channels for all fluorophores used. The sum signal is used for the localization of the fluorophore. Since regularly only one fluorophore fluoresces in the localization area, apart from background fluorescence, and since the different fluorophores of a pair differ in spectral emission, it can be deduced in each case from the ratio of the signals in the different detection channels which fluorophore type of the dye pair caused the signal. As a result, a specific dye can be assigned to each localization. Possible misassignments are minimized in a data analysis by means of a principal component analysis of the spectral components of all MINFLUX iterations. Since the localization is based on the knowledge about the positions of the minima of the intensity distributions of the excitation light alone, there is no color-dependent offset between localizations of the different fluorophores, since they are excited with identical excitation wavelengths. The experimental setup features two different lasers for excitation with an excitation donut, one with a wavelength of 642 nm and one with a wavelength of 560 nm. It is demonstrated that MINFLUX nanoscopy can also be performed with the use of photoactivatable fluorescent proteins, specifically mMaple, especially also on living cells; the excitation laser with a wavelength of 560 nm is obviously needed for the excitation of the fluorescent protein mMaple in the corresponding single-color MINFLUX imaging.

A largely identical method as in the publication mentioned above is discussed for the investigation of other samples in the publication “Multicolor 3D MINFLUX nanoscopy of mitochondrial MICOS proteins”, Jasmin Pape et al., PNAS,117 (34) 20607-20614, (2020), https://doi.org/10.1073/pnas.2009364117. In order to image densely packed structures, a special algorithm is used for the formation of localization clusters and the assignment of localizations to individual fluorophores, respectively. To select areas to be investigated with MINFLUX, a wide-field image is first acquired. A camera and a separate laser are used for this purpose.

Using MINFLUX nanoscopy, the position of fluorophores in two spatial directions could be determined experimentally with an uncertainty of only 1 nm, i.e. the accuracy of the position determination is comparable to the extension of the fluorophores themselves. If the position of a single fluorophore is to be determined with a given measurement uncertainty, this requires less time and, in particular, a smaller number of fluorescence photons than is the case when determining the position of a single fluorophore using conventional localization microscopy.

In the European disclosure EP 3 372 990 A1, in addition to other MINFLUX methods, a method similar to the MINFLUX method is described in one aspect. As in a MINFLUX method, a focused intensity distribution is applied to a singled molecule, which has a central minimum, preferably a zero, and increasing regions surrounding this; also as in MINFLUX, this minimum is placed at a plurality of scan points around the presumed location of the singled molecule and fluorescence emission is detected for each scan point; the actual position is estimated with high precision from the intensity values or photon numbers thus obtained. In contrast to MINFLUX, the intensity distribution is a distribution of fluorescence inhibition light, in particular STED light. This is applied together with excitation light, and the intensity distribution of excitation light has no central local minimum. While in MINFLUX the fluorescence emission is higher when the isolated molecule is further away from the central minimum of the intensity distribution, the reverse is true in this method.

The publication “Super-resolution microscopy demystified,” Lothar Schermelleh et. al, Nature Cell Biology, VOL 21, 72-84 (2019), https://doi.org/10.1038/s41556-018-0251-8, provides an up-to-date overview of super-resolution microscopy techniques, which the authors include those that do not transmit spatial frequency content above the maximum spatial frequency of confocal microscopy, but merely exhibit improved transmission of high spatial frequencies within the frequency spectrum given by diffraction limitation. These techniques include, for example, structured illumination microscopy (SIM) and image scanning microscopy. In the paper, the authors state that none of the known super-resolution techniques are suitable for all imaging purposes and that complementary techniques should therefore be used to address specific issues. Super-resolution microscopy offers scientists the opportunity to test and refine biological models; descriptive research is therefore becoming increasingly important alongside hypothesis-driven research if (patho)biological processes are to be understood. This publication also mentions correlative methods, in which images from different imaging techniques, for example a super-resolved image acquired by light optics, are correlated with an electron microscopic image.

Another overview of current techniques in super-resolution microscopy and nanoscopy including combined techniques such as a combination of STED microscopy with atomic force microscopy can be found in the review article “Optical nanoscopy,” A. Diaspro and P. Bianchini, Riv. Nuovo Cim. (2020). https://doi.org/10.1007/s40766-020-00008-1.

In the publication “High-resolution deep view microscopy of cells and tissues”, H. Schneckenburger et al, Quantum Electron. 50 2 (2020), https://doi.org/10.1070/QEL17204, various methods and devices for imaging thick biological samples are proposed. It is stated that high resolution is regularly achieved only when high numerical aperture objectives are used. These have only a small working distance, so that high-resolution imaging of thicker samples is not possible with them. The publication now proposes to illuminate a sample using a plurality of distributed apertures. In this way, a kind of focal point can be created at any depth of a sample. The light coming from the focus area can now be detected and high-resolution images can be generated. This is possible with both STED-like and MINFLUX-like illumination.

For example, from the publication “Lensfree on-chip microscopy based on dual-plane phase retrieval,” Cheng Guo et al, Opt. Express 27, 35216-35229 (2019), https://doi.org/10.1364/0E.27.035216, a method is known in which laser light transmitted through and affected by a sample is directly collected on a spatially resolving detector without using optical imaging elements. An image of the sample can be calculated from the signal. The method achieves an image resolution of about 1 μm. In principle, the method is not suitable for imaging fluorescent samples.

From the patent disclosure DE 10 2006 047 816 A1 a method and a device for high-resolution optical scanning of a sample dyed with several dyes are known. In the method, the sample is imaged by means of a STED process. According to the disclosure, imaging of the multiple dyes can be performed sequentially in such a way, among other things, that first a STED image of one dye is taken by complete scanning of an area of the sample to be examined and that another dye is imaged during a subsequent complete scan. In one embodiment, a common wavelength can be selected for the excitation of two dyes. The fluorescence of the two dyes can be separated by a wavelength sensitive element (filter) and the fluorescence of the two dyes can be registered with one detector each. The described device can have a detection device with several detectors, which can be switched off individually and/or in groups. The device, designed as a scanning microscope, can be adapted for use with dyes having a specific spectral characteristic.

A similar method for high-resolution optical scanning of a sample stained with at least two dyes as described in the aforementioned paper is described in DE 10 2006 011 556 A1. This method is characterized by the fact that the excitation spectra and excitation wavelengths of the two substances differ from each other.

### OBJECTIVE OF THE INVENTION

It is the object of the invention to provide improved methods for microscopic or nanoscopic imaging of a sample stained with multiple dyes. In particular, the methods should enable nanoscopic imaging with up to molecular resolution to be placed in the spatial context of microscopic images, or nanoscopic tracking of individual molecules to be performed in the spatial context of a microscopic image. This should also be possible on living biological objects.

### Solution

The task of the invention is solved by methods having the features of independent claims 1, 16, 23 and 25 and by a microscope having the features of claim 33. Dependent claims 2 to 15 concern preferred embodiments of the method according to claim 1, dependent claims 17 to 19 concern preferred embodiments of the method according to claim 16, dependent claims 20 to 22 concern preferred embodiments of both the method according to claim 1 and the method according to claim 16, dependent claim 24 relates to a preferred embodiment of the method according to claim 23, dependent claims 26 and 30 to 32 relate to preferred embodiments of the method according to claim 25, and dependent claims 27 to 29 relate to preferred embodiments of the methods according to independent claims 1, 16, 23 and 25; finally, dependent claims 34 to 39 concern preferred embodiments of the microscope according to claim 33.

### DESCRIPTION OF THE INVENTION

Regarding the Problem

Microscopy refers to methods that allow objects to be imaged with high resolution. High resolution initially only means that details of an imaged object are to be resolved that cannot be resolved when viewed with the naked eye. If the object is not observed with the naked eye, but data is recorded from which an image can be generated for observation, the magnification of the image by the optical components of the microscope loses its significance with regard to image generation. In addition to the resolution of the microscope, the size of the image field, or more generally the imagable volume, is critical to its applicability for the examination of a particular object or, in other words, for a particular examination task. If objects are to be examined, such as living cells or in living cells that change in time, the amount of time required to take an image becomes critically important. The demands placed on a microscope therefore depend in many ways on the examination task. Accordingly, there are a large number of different microscopes and microscopy methods.

For a large number of microscopy methods, the resolution is diffraction limited. In the field of fluorescence microscopy, the Rayleigh criterion is usually given to describe the diffraction limit quantitatively, and Abbe's diffraction limit is often mentioned in connection with the observation of scattered light. Although the resolution limit depends on details of the observation conditions, it is always proportional to the wavelength of the light used, and in practically relevant applications is about half the wavelength of the light used. The description of the resolution of a microscope can also be described by specifying the optical transfer function (OTF) or the modulation transfer function (MTF), which is the absolute value of the OTF. The MTF has a cutoff frequency above which it has a constant value of 0. For fluorescence microscopy with wide-field illumination, this cutoff frequency is fₙ=2 NA/λ, wherein NA is the numerical aperture of the imaging optics and λ is the wavelength of the fluorescent light; in the case of structured illumination, which in principle includes confocal illumination, the cutoff frequency is twice as large, so it is fₕ=4 NA/λ. The latter is valid under the assumption that the excitation and emission wavelengths do not differ significantly. This cutoff frequency is absolute for diffraction-limited methods and cannot be exceeded by special illumination structures, special imaging modalities, or deconvolution methods, unless deconvolution relies on prior knowledge gained elsewhere. In the case of simple confocal fluorescence microscopy, it should be noted that this cutoff frequency would only be achieved with an infinitesimally small pinhole, i.e., it cannot be achieved in practice. In practical applications, a pinhole is often used whose diameter corresponds to the diameter of the diffraction disk of the aperture diaphragm up to the first zero. Then the cutoff frequency of the MTF in confocal fluorescence microscopy corresponds exactly to that in wide-field fluorescence microscopy. These statements refer to the lateral resolution. With regard to the axial resolutions, the same applies, whereby the resolution is regularly worse in the axial direction, i.e., the minimum distance of separable details is larger, the cutoff frequency of the modulation transfer function is lower.

This resolution limit can be undercut using various known super-resolution techniques. These include STED microscopy, localization microscopy methods such as PALM or STORM, and methods using structured illumination and fluorescence saturation. However, the resolution of these methods still depends on the wavelength and is limited by the usable photon budget. In practice, such methods can achieve resolutions in the range of 30 nm down to 20 nm in more specific cases.

As discussed in the prior art section, MINFLUX nanoscopy now enables imaging at sub-2 nm resolution. Such resolution is referred to in this specification as molecular resolution because the 2 nm dimension corresponds approximately to the extent of individual fluorescent dye molecules; many dyes have even more extended molecules. It is expected that molecular resolution can also be achieved with methods involving MINFLUX-like scanning and localization using a distribution of fluorescence inhibition light with a central local minimum, such as that described in EP 3 372 990 A1, cited above. This method is subsequently referred to in this application as STED-MINFLUX. However, both methods are not very suitable for imaging typical biological samples in their entirety, mainly because of the high time requirement; as a rule, it will only be possible to examine sections of such an investigation using MINFLUX or STED-MINFLUX. In the case that fluorophores are available when using conventional methods of localization microscopy, such as PALM or STORM, which can emit very many photons before they are bleached, it is theoretically conceivable that molecular resolution can also be achieved with such methods. However, such methods are then also not very suitable for imaging typical biological samples in their entirety, again in particular because of a high time requirement. In order to be able to image biological samples in their entirety and at the same time to be able to image at least sections of particular interest with molecular resolution, it is therefore necessary to combine other imaging or microscopy methods with a method that achieves molecular resolution, in particular for example with MINFLUX.

However, several problems arise with such a combination. For example, it is desirable and in certain cases necessary with respect to the objectives of the examination of the sample that the image information obtained with the other method can be placed in spatial context with the molecularly resolved image information, and with great accuracy. To do this, however, it is necessary to image the sample with good quality before imaging with molecular resolution using the other method. The problem arises that during imaging with the other method, the sample is stressed, i.e., the fluorophores it contains are bleached. In this case, there is usually a correlation between the degree of bleaching and the resolution achieved with the other method, because even with such methods, which are fundamentally diffraction-limited, the resolution actually achieved depends on the photon budget used, since if only a few photons are used, the imaging quality is reduced by noise effects. The noise results on the one hand from the emission process itself, which results in a Poisson-distributed noise of the measured photon numbers, and on the other hand from the fact that detectors themselves exhibit a noise, which has a stronger influence on the image quality, the lower the photon numbers or intensities to be measured or measured are. At the same time, since imaging with molecular resolution requires that the fluorescent dyes to be used for this imaging are not bleached or only slightly bleached, a conflict of objectives arises.

For the imaging of biological samples or the structures contained in them, it is often necessary to stain the sample to be examined with several different dyes in order to be able to represent different structures in fluorescence microscopic images, delimited from one another but at the same time in their spatial relationship to one another. Now, in order to be able to image such multiple stained samples also with molecular resolution in a way where the different biological structures, each associated with different dyes, are delineated against each other, it is necessary to be able to distinguish between the fluorescence signals emitted by different dyes. Making this possible in a straightforward manner for a variety of different samples is complicated by the fact that a device and method that can distinguish well between two particular dyes may be unsuitable for separating other dyes. A further problem is that even if the spectral properties of the dyes with which a sample is dyed are known in principle, relevant deviations in the spectral properties of the dyes occur depending on the sample, e.g. on the pH of the sample, so that a separation with predetermined properties of the device and the method is not optimally successful.

The possibility of combining complementary methods is currently in many cases reserved for specialized laboratories. According to the above-mentioned article “Super-resolution microscopy demystified” (Lothar Schermelleh et. al), investigations on samples using super-resolution microscopy techniques would often have to be validated with investigations performed on different platforms.

A single platform, which on the one hand is suitable to be offered commercially for a broader user group and which on the other hand enables the imaging of biological samples, if necessary depending on the section of the sample, both with a diffraction-limited resolution of about 400 nm to 250 nm and with a super-resolution of about 50 nm to 30 nm and also with a molecular resolution, wherein overall image fields with lateral extensions of some to several millimeters can be recorded, is not known so far. Likewise, no methods are known that are suitable to offer the above-mentioned possibilities and at the same time to be implemented in such a way that they could be implemented in a microscope as a single platform as indicated above. This means that currently no corresponding methods are known for whose application a single platform could be easily realized.

Regarding the Solution

This is where the invention comes in and provides such methods which are particularly suitable for use in a common single platform, that is, a microscope. Further, it provides a microscope as such a single platform. The above-mentioned conflict of objectives is thereby resolved as far as possible.

The methods, which differ in detail, are based on a common inventive concept. The common purpose of all methods is that a provision of a single platform, i.e. a microscope, with which all methods are executable, is particularly simple. In all methods, image data of the sample or of a partial area of the sample are first acquired and a sample region of interest is determined and selected on the basis of the image data, in all methods, fluorescence photons emitted from the sample are detected in at least two different wavelength ranges, with the detection preferably taking place in each case in contiguous wavelength ranges and not spectrally resolved for each wavelength range.

In the context of the present specification (i.e., the first through sixth methods and the microscope), the term “non-spectrally resolved” means that the fluorescence detected within the respective contiguous or adjustable wavelength range is evaluated independently of the wavelength of the detected photons. Thus, no spectral information is collected and used within the adjustable wavelength ranges, i.e., no spectrum is recorded. Thereby, the detected fluorescence can be summarized to a total fluorescence value (e.g. a fluorescence intensity or a count rate per time unit obtained by photon counting). It is possible to split the detected fluorescence according to a parameter other than wavelength, for example, fluorescence lifetime.

Furthermore, all methods aim at providing an optimization for at least one of the imaging modes, i.e. that of the first acquisition of image data or a localization microscopic method. Overall, all methods aim at optimally using or making use of the dyes present in the sample for an imaging of a sample, wherein the imaging comprises both the imaging of structures in the size range of a few 10 micrometers to millimeters and the imaging of partial areas with molecular resolution. In this context, the tracking of a particle of a sample is regarded as a special form of imaging.

Specifically, the posed problem is solved by a first method for localization microscopic examination or for localization microscopic examination of a sample stained with multiple dyes, comprising the following steps:
a first acquisition of image data of the sample or a partial area of the sample,
a determination and selection of a sample region of interest based on the image data,
exciting fluorophores, in particular at least one of the multiple dyes, in a first subregion within the selected sample region of interest with excitation light of a first excitation wavelength and a first detection of the fluorescence photons emitted by the excited fluorophores in a first wavelength region with a first detection unit, and
a second detection of the fluorescence photons emitted by fluorophores excited with excitation light of the first excitation wavelength in a second wavelength range different from the first wavelength range with one or the first detection unit (in other words, with the first detection unit or with a further detection unit).

Such a method is known from the prior art, for example from the publication “Multicolor 3D MINFLUX nanoscopy of mitochondrial MICOS proteins” (Jasmin Pape et. al.) mentioned in the section on the prior art, or the associated Supplemental Information. There, the first imaging is performed exclusively in a wide-field method using an EMCCD camera.

In the first method according to the invention, although the first acquisition can be performed in basically the same way, it preferably comprises a scanning acquisition of image data.

By the term “fluorophores of multiple dyes” in the context of the present specification (i.e., the first through sixth methods and the microscope) is meant fluorescent molecules of several different species that differ, e.g., in their molecular structure and thus have, in particular, different excitation or emission spectra or different fluorescence lifetimes.

Compared to the prior art, the first method according to the invention is characterized in that,
in that the first detection unit is configured in such a way that the wavelength range (in particular the first wavelength range) in which it (i.e., the first detection unit) detects fluorescence photons is adjustable, and in that the method further comprises:
(in particular subsequently) a determination of wavelength ranges (in particular further wavelength ranges) for an optimized ratiometric separation of the multiple dyes in a localization microscopic image acquisition of the sample in multiple spectral detection channels.

In the context of the present specification (i.e., the first to sixth methods and the microscope), the term “ratiometric separation” of dyes means in particular a method in which a fluorophore (or the fluorescent light emitted by this fluorophore) can be assigned to one of the several dyes by determining a ratio of the numbers of fluorescence photons or fluorescence intensities detected in the two different wavelength ranges. In the context of this specification, the term “ratiometric separation” also includes the case where no fluorescence signal is detected in one of the wavelength ranges. The corresponding ratio would then be zero or “equal to infinity”, depending on whether it is defined as the quotient between the number or intensity detected in a first wavelength range and the number or intensity detected in a second wavelength range, or whether it is defined as the reciprocal of said quotient. Of course, even in this case, the assignment of a fluorophore to a particular dye can be based on the ratio. Furthermore, to achieve ratiometric separation as defined in this specification, the above ratio need not necessarily be formed. Rather, the signals measured in the two different wavelength ranges can also be evaluated in other ways to assign a fluorophore to one of the multiple dyes.

According to one embodiment, the first wavelength range and/or the second wavelength range for the optimized ratiometric separation of the dyes are adjusted, or adapted, based on the determined (further) wavelength ranges.

The wavelength ranges determined according to the method for optimized ratiometric separation of the multiple dyes can subsequently be used for a localization microscopic image, in particular a MINFLUX image, or they can alternatively or additionally be stored together with information about the sample, for example in a database.

In particular, localization or tracking of isolated fluorophores (at least one of the multiple dyes) is performed in the sample region of interest using a MINFLUX method or a STED-MINFLUX method, wherein detection of the fluorescence photons is performed in each case in the wavelength ranges determined for optimized ratiometric separation of the multiple dyes.

In the context of the present specification (i.e., with respect to the first through sixth methods and the microscope), the term “MINFLUX method” means a method in which a local intensity minimum (in particular, an intensity zero) of a light distribution (in particular, an excitation light distribution) is placed at a plurality of positions relative to the location of an isolated fluorophore, wherein the position of the fluorophore is estimated from the photon counts measured at the individual positions.

A STED-MINFLUX method, in the context of the present specification (i.e., with respect to the first through sixth methods and the microscope), means a method in which a local intensity minimum of a STED (stimulated emission depletion) light distribution is placed at a plurality of positions relative to the location of a isolated fluorophore illuminated with excitation light, wherein the position of the fluorophore is estimated from the photon counts measured at the individual positions.

In the context of the present specification, localizing isolated fluorophores means a method in which fluorescent fluorophores, i.e., fluorophores in an active state whose fluorescence photons are detectable in the excitation and emission wavelength range used, are spaced apart by a distance at least equal to the optical diffraction limit at the wavelengths used. This condition can be met, in particular, by choosing appropriate dye concentrations when labeling the sample and, in the case of photoactivatable or flashing dyes, by choosing activation light parameters (e.g., power or pulse rate) and/or buffer conditions. The overall density of fluorophores in the sample may well be chosen such that certain fluorophores have a spacing below the diffraction limit, as long as they are not simultaneously active or excited and/or detected in different wavelength ranges.

Depending on the properties of the sample, such a method can be carried out in a first further development in such a way that the first sub-region within the sample region of interest is selected on the basis of the image data in such a way that only or substantially only fluorophores of a first dye are contained therein and that a plurality of fluorophores are excited in the first sub-region with excitation light of the first excitation wavelength and that a first and a second value characterizing the spectral emission of the first dye are obtained from the first and the second detection. Such a selection of the first sub-region is possible and useful if in the first acquired image data structures are mapped of which the user knows that in these only the presence of a single type of dye is to be expected. Then the spectral properties of the dye in question can be determined very quickly in the specific sample environment, because this determination can then be carried out on an ensemble of a large number of fluorophores of the dye in question. This provides a large and thus low-noise signal without subjecting the individual dye molecules of the dye in question to greater exposure to excitation light. Already from the ratio of the numbers of fluorescence photons detected in the two differing wavelength ranges, or the fluorescence intensities, information can be obtained that allows optimized ratiometric separation of the different dyes. This is true both when the ratio of intensities corresponds to a pre-known intensity ratio and when it deviates significantly from such a pre-known ratio. It is also possible that conclusions about background signals can be drawn from the measured values obtained in the two wavelength ranges, which affect the wavelength ranges to be defined for optimized ratiometric separation.

This method according to the first further development can now be advantageously carried out in one embodiment by additionally selecting a second subregion and optionally further subregions within the sample region of interest on the basis of the image data in such a way that in it or in each of them exclusively or substantially only fluorophores of a second or a further dye are contained and that in the second or in each case in a further partial region a plurality of fluorophores is excited with excitation light of the first excitation wavelength and that a detection of the fluorescence photons emitted by the respective excited fluorophores takes place in the first and the second wavelength range and that in each case a first and a second value characterizing the spectral emission of the second or the respective further dye are obtained. In other words: Advantageously, correspondingly as for the first dye also for the second and optionally for further or all further dyes present in the sample a region is selected in which exclusively or almost exclusively dye molecules of the second or of the respective further dye are present. Conclusions of the same type as for the first dye can also be drawn from the new information obtained for this purpose alone. However, by comparing the ratios obtained for the different dyes, it is now possible to draw even better conclusions about wavelength ranges to be defined for optimized ratiometric separation. This embodiment can also be modified to use two new wavelength ranges instead of the first and second wavelength ranges. Preferably, the excitation within each sub-region may be performed in a manner that scans the sub-region or a section of the sub-region with focused excitation light. The use of focused excitation light makes it easier to selectively excite only within the subregion. Scanning reduces the local stress on the sample.

Both the first further development and its embodiment can now preferably be further developed in such a way that a further detection of the fluorescence photons emitted by fluorophores of the respectively selected dye, i.e. the first, the second or a dye of the further dyes, each excited with excitation light of the first excitation wavelength, takes place in one or more further wavelength ranges, which differ from one another and from the first and the second wavelength range, so that a plurality of values characterizing the spectral emission of the first, of the second or of one dye of the further dyes is obtained from the measurement on the sample dyed with multiple dyes. In other words, advantageously, especially if there is still too much uncertainty about the wavelength ranges to be defined for optimized ratiometric separation based on the values obtained from the previous measurements, measurements of fluorescence in at least one additional wavelength range are performed for each of the dyes. This improves the information about the emission spectra of the dyes concerned, so that in principle a better determination of the wavelength ranges to be defined for optimized ratiometric separation is possible. However, it should be noted that each measurement by means of excitation and detection stresses the sample, i.e., bleaches the sample, and thus reduces the photon budget available for the subsequent measurement or the density of the available fluorophores. The latter can be accepted if a different region within the sample or even a different sample can be used for the determination of the wavelength ranges to be defined for an optimized ratiometric separation than the region to be finally examined by localization microscopy. It is also possible to use a sample that is already satisfactorily imaged for a determination of the wavelength ranges to be defined for an optimized ratiometric separation, so that the values obtained from this can be used for other comparable samples.

In a second further development of the first method, the first sub-region within the sample region of interest is selected based on the image data to contain fluorophores of multiple dyes, and isolated fluorophores are repeatedly excited within the first sub-region, with fluorophores of all of the multiple dyes being excited in total. Excitation within the first sub-region may be performed in a manner such that the sub-region or a portion of the sub-region is scanned with focused excitation light. The use of focused excitation light facilitates selective excitation only within the subregion. Scanning facilitates the detection of isolated molecules that are in a state excitable for fluorescence during a relevant time interval. Alternatively or additionally, activation light can be used in particular, which is applied to the, for example, focal region, which is also exposed to excitation light, in order to switch fluorophores in it from a state that cannot be excited to fluorescence to an excitable state. Activation then does not occur as long as fluorescence can be detected from the singled molecule. When this molecule has switched from the fluorescence-excitable state to a non-excitable state, activation can then be repeated until fluorescence can again be detected from an isolated molecule. Since multiple dyes are present in the subregion, fluorescence from the multiple dyes is detected in this manner with multiple repetitions.

In principle, even with this second further development, detection in both the first and second wavelength ranges could be performed with the same detection unit. However, this seems to be hardly practicable and it leads to an increased stress on the sample. Therefore, it is strongly preferred, especially in this further development of the first method, that the detection of the fluorescence photons in the first and in the second wavelength range is performed on separate (or by means of separate) detection devices or detection units that are active simultaneously. This is also preferred in the first further development. Compared to the detection with only one detection device or detection unit, which is adjusted once to the first wavelength range and once to the second wavelength range, it has the advantage that the acquisition of the spectral information is faster on the one hand, but on the other hand is also accompanied by a lower stress on the sample.

The second further development of the first method can now preferably be designed in such a way that a further excitation of fluorophores with excitation light of the first excitation wavelength and a further detection in two further wavelength ranges takes place, wherein at least one of the two further wavelength ranges is neither the first nor the second wavelength range. This basically improves the information that can be used to determine wavelength ranges for optimized ratiometric separation. However, similar to a corresponding embodiment of the first further development, it should also be noted here, for example, that any excitation leads to stress on the sample that reduces the photon budget or density of available fluorophores that can be used for molecular resolution imaging.

In both the first further embodiment and the second further embodiment, it may be preferred that the first wavelength region and the second wavelength region are adjacent to each other at a first threshold wavelength. It may then be further preferred that respective further wavelength regions used in further detection are also adjacent to each other at a threshold wavelength or a further threshold wavelength, and it may also be preferred that further excitation and detection is performed multiple times, with a different further threshold wavelength being selected in each case.

Both further embodiments can also advantageously be designed in such a way that the first wavelength range and/or one of the further wavelength ranges comprises wavelengths that are smaller than the first excitation wavelength; preferably, they can be designed in such a way that the first wavelength range and/or one of the further wavelength ranges exclusively comprises wavelengths that are smaller than the first excitation wavelength. In particular with this preferred design, comparatively little fluorescence can be detected in the relevant wavelength range. The advantage, however, is that especially in the wavelength range below the excitation wavelength the fluorescence emission of different dyes can show very large differences to each other, so that a ratiometric separation of the dyes is particularly well possible. For subsequent localization with molecular resolution, the other wavelength range will then essentially be used, while the wavelength range below the excitation wavelength will only be used for assigning a localization to a dye. In this embodiment, if the first wavelength region comprises exclusively wavelengths smaller than the first excitation wavelength, it will preferably just not be adjacent to the second wavelength region. The same applies to further wavelength ranges used in further detection. Here, in each case, the wavelength range that exclusively comprises wavelengths that are smaller than the first excitation wavelength is not adjacent to the respective other further wavelength range. Rather, preferably just the excitation wavelength will not be included in any of the wavelength ranges. This generally has the advantage that scattered excitation light cannot distort the fluorescence detection. Furthermore, this allows the excitation light to be coupled into a beam path shared for excitation and detection by means of a color splitter, which can then preferably be designed as a narrow-band color splitter with a bandwidth of a few nanometers, for example less than 15 nm, 10 nm or 5 nm.

The second further development can preferably be designed in such a way that an assignment of fluorescence photons detected in each case during the detection in two wavelength ranges, in the first and the second wavelength range and/or in one and another wavelength range of the two further wavelength ranges, to bursts of the isolated fluorophores is carried out and that the numbers of the fluorescence photons detected in the one and the other wavelength range are determined for the bursts in each case. Histograms are therefore formed. Preferably, the wavelength ranges for optimized ratiometric separation are then determined from these histograms. It is known from the prior art how the quality of the separation of the dyes can be assessed from such histograms. If several histograms are available, it is now possible to assess which histogram and thus which selection of wavelength ranges leads to the best ratiometric separation.

Advantageously, in all the methods described above, the alternately different wavelength ranges do not overlap. This means that the first and second wavelength ranges do not overlap and, if measurements are repeatedly made in several wavelength ranges, the wavelength ranges used in one step of the repetition do not overlap. This approach has the advantage that it can be easily implemented in terms of apparatus, for example using a detection apparatus with two or more individual detection units, as is known from the patent specification DE 10 2018 126 232 B3 mentioned at the beginning in the section on the prior art.

Preferably, in the first method and its two embodiments, an acquisition step of the first acquisition of image data is performed by scanning the sample or a section of the sample with an excitation light by means of a first deflection unit located in the optical path of the excitation light. The excitation light used in the first acquisition of image data may be the excitation light of the first excitation wavelength, but it may also be excitation light of a different wavelength or have the first excitation wavelength but come from a light source other than the excitation light of the first wavelength. The advantage of scanning by means of the first deflection unit located in the beam path of the excitation light is that the beam paths of the excitation light used for scanning during the first acquisition and the excitation light of the first wavelength can be more easily adjusted with respect to each other or can be maintained in an adjusted state. This facilitates that actually the partial areas selected in the image obtained during the first acquisition of image data are actually exposed to the first excitation light.

In a preferred embodiment, this applies mutatis mutandis explicitly to all methods according to the invention, but possibly as an obligatory feature, the first acquisition comprises confocal scanning or joint scanning with focused excitation and fluorescence inhibition light, preferably with STED light. Confocal scanning here means that the fluorescence emission is detected in a confocally descanned manner. Confocal detection is also present here if a detection unit is arranged in the focal plane of the detection, which has a plurality of apertures assigned to individual detector elements or detectors, which are extended and arranged in such a way that the diffraction image of a point light source is detected in a spatially resolved manner. Such a detection unit can also be used in conjunction with the application of fluorescence inhibition light. Further preferably, in this case, the detection during confocal scanning or joint scanning with focused excitation and fluorescence inhibition light takes place in a contiguous wavelength range and is not spectrally resolved. The advantage of this is that by choosing a contiguous wavelength range and not using spectral resolution within this wavelength range, the entire amount of light from the selected wavelength band is detected with exactly one detector, so that the signal obtained during the measurement process also contains the noise from only one detector. This enables high imaging quality at low irradiance. Another advantage is when the sample is hardly known at the beginning of the scanning process. It is then not possible to select an imaging method that is already optimally matched to the sample structure using multiple detection wavelengths. However, by selecting a contiguous wavelength range for detection, it is possible to ensure that all fluorescence emitted within the wavelength range is detected. Although discrimination of different dyes is not possible in this way, in the majority of cases an image data set suitable for selection of regions of interest and of sub-regions within a region of interest is still obtained.

In a further embodiment, this applies mutatis mutandis expressly to all methods according to the invention, the first acquisition of image data in the first method comprises an acquisition step according to a differential interference contrast method, preferably according to a scanning differential interference contrast method. A differential interference contrast method has the advantage that the fluorophores contained in the sample are not, or at least extremely little, stressed, i.e. bleached, during imaging. The selection of a scanning differential interference contrast method has the advantage that the first deflection unit can be used for the scanning process. This in turn allows, for example, that the first acquisition of image data can comprise an acquisition by means of a scanning differential interference contrast method, then a selection of a region of the sample that can subsequently be imaged as part of the first acquisition by means of confocal scanning or by means of joint scanning with focused excitation and fluorescence inhibition light, preferably with STED light. In the last image obtained, the region of interest and the subregion(s) are then selected, and consideration of the differential interference contrast image can be made. Since the same deflection unit is used in both methods applied during the first acquisition, the images are well aligned relative to each other.

As a rule, detection is also performed in a descanned manner in the case of imaging according to a STED method, often with the use of confocal detection. In addition or alternatively to the confocal detection or the descanned detection, a wide-field detection can also be performed. If this is done in addition, the image obtained with wide-field detection can be aligned with the image obtained with descanned detection.

In all methods according to the invention except the fifth, the first acquisition of image data may also comprise an acquisition step according to a wide-field fluorescence method, i.e., according to a method in which excitation is also performed by means of wide-field illumination. For example, an overview image can first be acquired using wide-field fluorescence microscopy, and an area can be selected in the overview image to be scanned confocally. During confocal scanning, wide-field detection can then additionally be performed, particularly in edge regions of the selected area. Based on the parts of the image imaged both in wide field and descanned, the wide field image and the scanned image can be aligned. In the aligned scanning image, the region of interest and the partial region or regions can then be selected.

In a further embodiment, the first method comprises localizing or tracking isolated fluorophores according to a MINFLUX method or a STED-MINFLUX method in the region of interest, wherein the detection of the fluorescence photons is performed in each case in the wavelength ranges determined for an optimized ratiometric separation of the multiple dyes. Alternatively or additionally, the wavelength ranges determined for an optimized ratiometric separation of the multiple dyes are stored in a database, wherein the term database is to be interpreted broadly here. It is only important that the corresponding data are stored together with further data in such a way that they can be accessed during subsequent investigations on the same or on other comparable samples.

The second method according to the invention is a method for localization microscopic examination of a sample stained with multiple dyes. It comprises:
a first acquisition of image data of the sample or a partial area of the sample,
determining and selecting a sample region of interest based on the image data such that fluorophores of multiple dyes are contained in the sample region of interest,
(in particular in the sample region of interest) localizing isolated fluorophores of the multiple dyes according to a MINFLUX method, wherein excitation with excitation light of a first excitation wavelength is performed and wherein detection of the fluorescence photons is respectively performed in a first and a second wavelength range, which is different from the first wavelength range.

Such a method is also known from the prior art, for example from the publication “Multicolor 3D MINFLUX nanoscopy of mitochondrial MICOS proteins” (Jasmin Pape et. al.) mentioned in the section on the prior art, or the associated Supplemental Information. Compared to the prior art, the second method according to the invention is characterized in that it further comprises:
(in particular subsequently in the sample region of interest) localizing the isolated fluorophores of the multiple dyes according to a MINFLUX method or a STED-MINFLUX method, wherein the detection of the fluorescence photons takes place in each case in two further wavelength ranges, wherein at least one of the two further wavelength ranges coincides neither with the first nor with the second wavelength range.

Thus, in contrast to the prior art, when performing localization using the MINFLUX method, detection is not performed exclusively in two predetermined wavelength ranges, but further localization is performed, with detection in at least one additional wavelength range. In this way, during the execution of a sample imaging, it is possible to search for wavelength ranges that allow an optimal separation. It is not necessary to perform detection in more than two wavelength regions for each individual isolated fluorophore. Rather, it is possible to localize a single isolated fluorophore or even a plurality of isolated fluorophores at a time using only two wavelength regions and then localize another isolated fluorophore or even another plurality of isolated fluorophores using only two wavelength regions, at least one of which does not match any of those first used. This includes determining a first image of the region of interest using only two wavelength regions, and then determining another image of the region of interest using at least a third or different wavelength region. The images then differ with respect to the proportions of localizations assigned to an incorrect dye.

Preferably, the second method is carried out in such a way that the localization of isolated molecules is started using two wavelength ranges. While this is being carried out, or subsequently, the fluorescence signals are evaluated to determine whether good ratiometric separation of the dyes is possible. This can preferably be done by forming and evaluating histograms, as explained above in connection with the first method in the second further development. At least once, at least one wavelength range is now changed and further isolated molecules are localized. With reference to the changed wavelength ranges, a further histogram can now be formed. The data obtained are checked to see which wavelength ranges can be used for optimal ratiometric separation. In this way, while imaging the sample using MINFLUX or STED-MINFLUX, which should also include particle tracking, wavelength ranges optimized for ratiometric separation of the multiple dyes can be determined.

It is also possible that the wavelength ranges to be used for optimized ratiometric separation of the multiple dyes change during imaging or that they are different in different subregions of the region of interest. According to the method, optimized wavelength ranges for a ratiometric separation of the multiple dyes can now be determined continuously and/or depending on sub-ranges to be imaged and applied accordingly. Such changes can result, for example, both from a change in the fluorescence properties of the dyes used in the sample itself, but they can also result from a change in background fluorescence or from, in particular, a location dependence of the abundances of the fluorophores used. It may also depend on the specific measurement task, which may be location-dependent. For example, in one subarea it may be important that a particular dye is detected with particular sensitivity during localization, while at the same time it is not very critical if the localization of another dye is incorrectly assigned to the particular dye, and it may be important in another area that incorrect assignments in particular are excluded. Therefore, in one embodiment, the second method includes the ability for a user to define and provide criteria via an input device to a control and/or computing unit that determine what it means wavelength ranges are optimized for ratiometric separation of the multiple dyes. In a further preferred embodiment, it is provided that a user defines and passes criteria during the execution of the method, for example after the first acquisition, but preferably in particular during the execution of the MINFLUX or STED-MINFLUX method; this also includes that the execution of the MINFLUX or STED-MINFLUX method is interrupted while the user defines and passes the criteria.

Also in the second method it may be preferred that the first and the second wavelength regions are adjacent to each other at a first threshold wavelength; that the two further wavelength regions are adjacent to each other at a further threshold wavelength which does not coincide with the first threshold wavelength; that the first wavelength range and/or one of the further wavelength ranges comprises wavelengths which are smaller than the first excitation wavelength, preferably exclusively comprises wavelengths which are smaller than the first excitation wavelength; that the first acquisition of image data comprises an acquisition step comprising a scanning of the sample, the scanning being performed by applying a first deflection unit in the optical path of the excitation light; that the scanning comprises a confocal scanning or a joint scanning with focused excitation and fluorescence inhibition light, preferably with STED light; and that the detection in the confocal scanning or the joint scanning with focused excitation and fluorescence inhibition light is in a contiguous wavelength range and not spectrally resolved. For the respective effects and advantages of the technical measures associated with the features, what has been set forth above in connection with the first method in the second further development applies.

Details of further preferred embodiments are already given above in connection with the description of the first method. It is indicated there which details refer expressly to all method, i.e. also to this second method.

The third method according to the invention is a further method for the localization microscopic examination of a sample stained with several dyes. It corresponds in its generic portion to the second method. It thus comprises:
a first acquisition of image data of the sample or a partial area of the sample,
determining and selecting a sample region of interest based on the image data such that fluorophores of multiple dyes are contained in the sample region of interest,
(in the sample region of interest) localizing isolated fluorophores of the multiple dyes by a MINFLUX method or a STED-MINFLUX method, wherein excitation with excitation light of a first excitation wavelength is performed, and wherein detection of the fluorescence photons is performed in a first and a second wavelength range, respectively, different from the first wavelength range.

Compared to the prior art, the third method according to the invention is characterized in that the first acquisition of image data of the sample or of one or the partial area of the sample comprises an acquisition step with a confocal scanning or a joint scanning with focused excitation and fluorescence inhibition light, preferably with STED light, wherein the detection is performed in a contiguous wavelength range and not spectrally resolved. Thus, in contrast to the prior art, the first acquisition is not exclusively acquired in a wide-field method. By choosing one of the indicated scanning methods, a higher resolution of the image obtained during the first acquisition is achieved. At the same time, non-spectrally resolved detection in a contiguous wavelength range makes it possible to achieve the high resolution with a comparatively low sample stress. A lower stress, but also a lower sample stress is achieved when confocal scanning is selected; conversely, the selection of, for example, STED scanning leads to a higher resolution.

Preferably, the scanning can now be performed with a deflection unit which is located in the beam path of the excitation light of the first wavelength. The advantages of this measure and details of further preferred embodiments are described further above in connection with the description of the first method. It is made clear in the description which explanations are expressly directed mutatis mutandis to all methods, and thus also to this third method.

The fourth method according to the invention is also a method for localization microscopic examination of a sample stained with multiple dyes. More specifically, the method is directed to the application to samples containing dyes with strongly different excitation or absorption spectra. For example, these may have absorption maxima that are mutually spectrally spaced by 120 nm or more. The distinguishability of the dyes therefore does not necessarily have to be ensured by detection in several wavelength ranges, but can in principle also be achieved by separate excitation. The method according to the invention now achieves an optimized data acquisition with minimal stress on the sample and shortened acquisition time, but precisely using two wavelength ranges in which detection takes place and the use of two excitation wavelengths.

The fourth method comprises:
a first acquisition of image data of the sample or a partial area of the sample,
determining and selecting a sample region of interest based on the image data such that fluorophores of multiple dyes are contained in the sample region of interest,
(particularly in the sample region of interest) a localization of isolated fluorophores of the multiple dyes by a MINFLUX method or a STED-MINFLUX method.

Compared to the prior art, the fourth method according to the invention is characterized in that it further comprises:
Before localizing by the MINFLUX method or the STED-MINFLUX method, first illuminating an isolated fluorophore in a first subregion within the selected sample region of interest with excitation light of a first excitation wavelength and with excitation light of a second excitation wavelength, thereby exciting the isolated fluorophore to fluorescence,
detecting fluorescence photons emitted from the excited fluorophore in a first and a second wavelength range different from the first wavelength range and obtaining a first and a second detection value,
selecting an excitation wavelength with which the isolated molecule is excited to fluorescence for localization by the MINFLUX method or the STED-MINFLUX method, and performing the localization using excitation light of the selected excitation wavelength as the only excitation light.

By using multiple excitation wavelengths, it is possible to use multiple dyes with widely different excitation spectra for multicolor imaging using a MINFLUX or STED-MINFLUX method. This is an important advantage, since one objective of the invention is to place a nanoscopic image with up to molecular resolution in the spatial context of microscopic images or to perform nanoscopic tracking of single molecules in the spatial context of a microscopic image. For example, in confocal microscopy, fluorophore pairings with partners separated via excitation are regularly used. The method according to the invention allows the use of such pairs also for MINFLUX microscopy. Even if the use of several excitation wavelengths instead of only one has a disadvantage with regard to the colocalizability of the different fluorophores, the advantage outweighs the disadvantage here. At least the partial images acquired by means of one of the two excitation wavelengths used can each be embedded well, i.e. with an accuracy corresponding to the spatial resolution of the first acquisition, in the image obtained during the first acquisition.

The method also differs from the prior art in that excitation light of both a first and a second wavelength is used to find the isolated fluorophores. This light is preferably directed simultaneously, but alternatively also in rapid alternation, focused onto or into the sample; focused also includes those intensity distributions that exhibit a central minimum. The advantage of this measure is that isolated fluorophores in an excitable state can be found and localized independently of the dye to which they belong.

Detection in two wavelength ranges, preferably with two simultaneously active detection units, makes it possible to identify immediately after detection to which dye a detected isolated fluorophore belongs. This is a prerequisite for the further measure of selecting an excitation wavelength for localization and applying it during localization. Here, the selected wavelength can also be a different wavelength than the first and second wavelengths that were used in the finding.

For example, it may be useful to use wavelengths for finding that strongly excite one of the fluorophores at a time, which minimizes the risk of not finding an isolated fluorophore that is in an excitable state. In principle, one of these wavelengths can then also be used for localization. It is then not necessary for the microscope to be able to provide another excitation wavelength. However, it may also be useful to select a different excitation wavelength for localization, for example, if the other wavelength causes a greater reduction in background fluorescence than the excitation of the isolated fluorophore is reduced.

Finally, the fact that excitation light of the selected excitation wavelength is used as the only excitation light has several advantages. If the sample were additionally exposed to non-selected excitation light, this would cause an increase in background fluorescence, there would be an increased risk that the separation of the fluorophore just to be localized would be cancelled or disturbed by the fact that a fluorophore, which is excitable by the additional excitation light, would change to an excitable state in the immediate vicinity and become excited, and the sample would be unnecessarily stressed and bleached.

Details of further preferred embodiments are already given above in connection with the description of the first method. It is indicated there which details expressly refer mutatis mutandis to all method, i.e. also to this fourth method.

The fifth method is another method for localization microscopic examination of a sample stained with multiple dyes. It comprises:
a first acquisition of image data of the sample or a part of the sample by
   i) a confocal scanning of the sample or the partial area of the sample with focused excitation light of a first excitation wavelength or by a joint scanning with focused excitation light of a first excitation wavelength and fluorescence inhibition light, preferably STED light, and detecting the fluorescence photons emitted by the excited fluorophores in a first wavelength range with a detection unit, and by
   ii) subsequent confocal scanning of the sample or the partial region of the sample with focused excitation light of a second excitation wavelength or by joint scanning with focused excitation light of a second excitation wavelength and fluorescence inhibition light, preferably STED light, and detection of the fluorescence photons emitted by the excited fluorophores in a second wavelength region wavelength range, which does not coincide with the first wavelength range, with the detection unit, wherein the first and the second wavelength range are in each case contiguous and wherein the detection in the first and the second wavelength range is in each case not spectrally resolved and wherein the detection unit is set accordingly for the respective detection,
determining and selecting a sample region of interest based on the image data or a portion of the image data, wherein fluorophores of a plurality of dyes are included in the sample region of interest,
(in particular in the sample region of interest) a localization of isolated fluorophores of a first dye according to a MINFLUX method or a STED-MINFLUX method, in particular a MINFLUX method, wherein excitation light of the first excitation wavelength is used for an excitation of the isolated fluorophores and wherein the fluorescence photons emitted by the excited isolated fluorophores are detected with the detection unit in a third wavelength range,
(in particular in the sample region of interest) a localization of isolated fluorophores of a second dye according to a MINFLUX method or a STED-MINFLUX method, in particular a MINFLUX method, wherein excitation light of the second excitation wavelength is used for an excitation of the isolated fluorophores and wherein the fluorescence photons emitted by the excited isolated fluorophores are detected with the detection unit in a fourth wavelength range.

By the phrase “a first acquisition of image data of the sample or a portion of the sample by”, the method is not intended to be limited to preclude combination with other image acquisition methods of the type described in connection with the other methods.

This method is directed to an application to a microscope having only one detection unit suitable for detection in a confocal or STED image acquisition and in a MINFLUX or STED-MINFLUX image acquisition. This does not preclude the microscope from having no other detection unit. It simply means that the microscope has only one appropriately suitable detection unit. This can mean, for example, that the microscope on which the method can be usefully carried out has exactly one particularly low-noise detection unit or exactly one sensitive microarray that is designed to detect diffraction images of a point light source with spatial resolution. Another prerequisite for the useful application of the method is that the sample comprises dyes that differ strongly in their excitation or absorption spectra. These can, for example, have absorption maxima that are spectrally separated from each other by 120 nm or more.

According to the method, a first image is acquired during the first acquisition using a confocal method or a STED method. The detection is not spectrally resolved in a first coherent wavelength range. The excitation is performed with light of a first excitation wavelength. Subsequently, as a further part of the first acquisition, a second image is acquired according to a confocal method or according to a STED method. Here, the detection is not spectrally resolved in a second contiguous wavelength range different from the first. Excitation is performed with light of a second excitation wavelength. Subsequently, a sample region of interest is selected. Optionally, a sample region of interest or a sample region encompassing the sample region of interest may also be determined after acquiring the first image. Then, the acquisition of the second image is preferably limited to this region. Selecting the sample region of interest after capturing the second image may then be selecting that region, or it may comprise re-determining a sample region of interest from the second image or from the first and second images.

From the acquired images, conclusions can already be drawn about wavelength ranges to be selected for optimized ratiometric separation of the multiple dyes in a localization microscopy image acquisition. Optionally, optimized wavelength ranges are therefore determined after the first acquisition. For example, conclusions about the background fluorescence that occurs can also be drawn from the acquired images. Accordingly, it can be advantageous to determine the optimized wavelength ranges on the basis of the acquired images in such a way that a minimized interfering background fluorescence, in particular, can be expected in a subsequent localization microscopic image.

After completion of the first acquisition, imaging of the sample region of interest is performed, or more precisely, localization of isolated fluorophores in the sample region of interest is performed according to a MINFLUX or a STED-MINFLUX method, using excitation light of the first wavelength for localization. Detection is performed in a wavelength range matched to the dye of the fluorophore to be localized. This can be the first wavelength range, but it can also be different from it. Accordingly, after completion of the first acquisition, localization of isolated fluorophores in the sample region of interest takes place, according to a MINFLUX or a STED-MINFLUX method, using excitation light of the second wavelength for localization. Detection is performed in a wavelength range matched to the dye of the fluorophore to be localized. This can be the second wavelength range, but it can also be different from it. The sequence of the two localization steps can be freely selected. Since switching the wavelength range in which the detection device (or the detection unit) detects takes time, it is usually convenient to perform at least some localizations using the excitation light of the first wavelength one after the other and to do the same for localizations using the excitation light of the second wavelength. For example, the region of interest of the sample can first be completely localized using the excitation light of one wavelength and then using the excitation light of the other wavelength.

In an alternative embodiment, similar to the fourth method and for corresponding reasons, different excitation wavelengths may also be selected here for performing the localizations according to the MINFLUX or the STED-MINFLUX method than for performing the first acquisition.

A sixth method according to the invention for localization microscopic examination of a sample stained with multiple dyes combines the previously discussed effects and advantages of the fourth and fifth methods. The method comprises first acquiring image data of the sample or a portion of the sample, determining and selecting a sample region of interest based on the image data such that fluorophores of multiple dyes are contained in the sample region of interest, and (particularly in the sample region of interest) localizing an isolated fluorophore of the multiple dyes according to a MINFLUX method or a STED-MINFLUX method.

According to the invention, prior to localization by the MINFLUX method or the STED-MINFLUX method, the method further comprises: illuminating the isolated fluorophore(s) with excitation light of a first excitation wavelength and a second excitation wavelength, thereby exciting the isolated fluorophore(s) to fluorescence; detecting fluorescent photons emitted from the excited fluorophore(s) in a first and a second wavelength range different from the first wavelength range, and selecting an excitation wavelength or excitation wavelengths at which the isolated fluorophore or fluorophores are excited to fluoresce for localization by the MINFLUX method or the STED-MINFLUX method.

According to a first embodiment of the sixth method equivalent to the fourth method of the invention described above, the first illumination of the isolated fluorophore is performed in a first subregion within the selected sample region of interest, wherein a first and a second detection value are obtained from the fluorescence photons detected in the first wavelength region and the second wavelength region, and wherein the localization is performed using excitation light of the selected excitation wavelength as the only excitation light. All of the embodiments and variations described in this specification that are disclosed for or combinable with the fourth method may also be combined with the first embodiment of the sixth method.

Furthermore, the invention comprises a second embodiment of the sixth method equivalent to the fifth method described above, in which the first acquisition of image data is performed by i) confocal scanning of the sample or the partial region of the sample with focused excitation light of the first excitation wavelength or by joint scanning with focused excitation light of the first excitation wavelength and fluorescence inhibition light, preferably STED light, and detecting the fluorescence photons emitted by the excited fluorophores in the first wavelength range with a detection unit, and ii) by subsequently confocally scanning the sample or the portion of the sample with focused excitation light of a second excitation wavelength or by jointly scanning with focused excitation light of the second excitation wavelength and fluorescence inhibition light, preferably STED light, and detecting the fluorescence photons emitted by the excited fluorophores in a second wavelength region which does not coincide with the first wavelength range, with the detection unit, wherein the first and the second wavelength range are contiguous in each case, and wherein the detection in the first and the second wavelength range is not spectrally resolved in each case, and wherein the detection unit is set accordingly for the respective detection, and wherein, in localizing the isolated fluorophores of the first dye, excitation light of the first excitation wavelength is used for exciting the isolated fluorophores, and the fluorescence photons emitted from the excited isolated fluorophores are detected with the detection unit in a third wavelength region, and in localizing the isolated fluorophores of the second dye, excitation light of the second excitation wavelength is used for exciting the isolated fluorophores and the fluorescence photons emitted from the excited isolated fluorophores are detected with the detection unit in a fourth wavelength range. Localization of the isolated fluorophores of both the second dye and the third dye is performed in particular according to a MINFLUX method.

Finally, the microscope according to the invention is configured for carrying out one of the methods according to the invention, preferably for carrying out the first to sixth methods. The microscope according to the invention comprises
a laser to excite fluorescence,
a scanning unit for scanning a sample with focused excitation light,
a detection unit configured to detect fluorescence photons, which are guided from the sample via an optical path into a plane conjugate to the focus of the excitation light, within adjustable spectral ranges in a non-spectrally resolved manner, and
a device, preferably a variably adjustable wavefront modulator, for influencing a wavefront of excitation light in such a way that the excitation light forms an intensity distribution with a central minimum at the location of the sample in a focal area, and
a control unit set up to carry out a MINFLUX method on.

In particular, the control unit is configured to perform any of the previously described methods, i.e., the first through sixth methods.

Preferably, the microscope comprises at least two detection units, each of which is configured to detect fluorescence within adjustable spectral ranges in a non-spectrally resolved manner, whereby preferably at least one of the detection units is set up to detect a diffraction image of a point object in a spatially resolved manner. Such a microscope can then generally also be used to carry out the fifth method, but since it has more than one suitable detection unit in this preferred variant, this is of little use.

Preferably, the microscope comprises a stand with a sample carrier, an objective which is held in an objective changing device, and a tube lens, wherein the scanning unit, the tube lens, and the objective are arranged along an optical path, and wherein the detection unit is arranged in an optical path comprising the objective, the tube lens, and the scanning unit. This design has the advantage that basic components that can also be used for microscopes not according to the invention can be used extensively for the microscope according to the invention. Preferably, the microscope comprises several different objectives in the objective changing device. This makes it possible to use objectives of different magnifications in order to record image fields of different sizes with them. For example, the first acquisition in the procedures can easily be carried out in such a way that first an overview image is acquired with a low magnification objective and then a sectional image is acquired with a higher magnification objective.

The use of a stand also has the advantage that further components can be added comparatively easily. For example, a detector for capturing images by detecting a differential interference contrast can be attached to the stand. Accordingly, the microscope preferably comprises such a detector for detecting a differential interference contrast which is detachably attachable to the stand. It is intended to be detachably attachable so that when it is not needed it does not take up space in an optical path and prevent its use for other purposes, for example direct visual observation by an observer. If the microscope includes such a detector, then the control unit of the microscope is preferably connected or connectable to the detector for detecting a differential interference contrast and is also arranged to drive the detector and process its detection signals.

In one variant, the microscope comprises a wide-field detector. When using a stand, this can be connected to a camera port on the stand, for example.

Preferably, the microscope comprises a further deflection unit located in an optical path to the illumination of the sample and not in the path to the detection unit. This unit is arranged to provide extremely fast scanning, particularly useful for performing the MINFLUX or STED-MINFLUX method, but to very small areas having extents on the order of 1 μm. Such a unit may be, for example, an electro-optical deflection unit or may be composed of several electro-optical deflection units.

Alternatively, the first deflection unit may also be configured to perform the small-scale scanning. This generally slows down the scanning process, but considerably reduces the amount of equipment required. In particular, since the microscope according to the invention as a whole is also designed to record high-resolution images by means of methods other than the MINFLUX method or, in particular when integrating a STED laser, super-resolution images, this variant can be useful, since carrying out the MINFLUX method is not necessarily the main application and is only carried out when there is a particular need, so that the loss of time is less significant.

Preferably, the microscope then comprises a pulsed laser for illuminating the sample with fluorescence inhibition light, preferably STED light. Further preferably, the control unit is configured to perform a STED-MINFLUX process.

From the foregoing explanations of preferred embodiments of the methods according to the invention, corresponding preferred embodiments of the microscope according to the invention are obtained.

With regard to the disclosure content—not the scope of protection—of the original application documents and the patent, the following applies: Further features can be found in the drawings—in particular in the flowcharts shown. The combination of features of different embodiments of the invention or of features of different patent claims is also possible in deviation from the selected back-relationships of the patent claims and is hereby suggested. This also applies to such features which are shown in separate drawings, can be taken from the flowcharts or are mentioned in the description of the drawings or the flowcharts. These features can also be combined with features of different patent claims. Likewise, features listed in the patent claims may be omitted for further embodiments of the invention, but this does not apply to the independent claims of the issued patent.

### DESCRIPTION OF FIGURES AND EXPLANATION OF THE INVENTION BY MEANS OF THE FIGURES

In the following, the invention is further explained and described with reference to preferred embodiments shown in the figures.

FIG. 1 shows schematically a microscope according to the invention

FIG. 2 schematically illustrates the sequence of imaging a sample starting from a large image field to imaging a section with molecular resolution

FIG. 3 illustrates preferred embodiments of the fifth, fourth and third methods

FIG. 4 illustrates preferred embodiments of the second and the first method

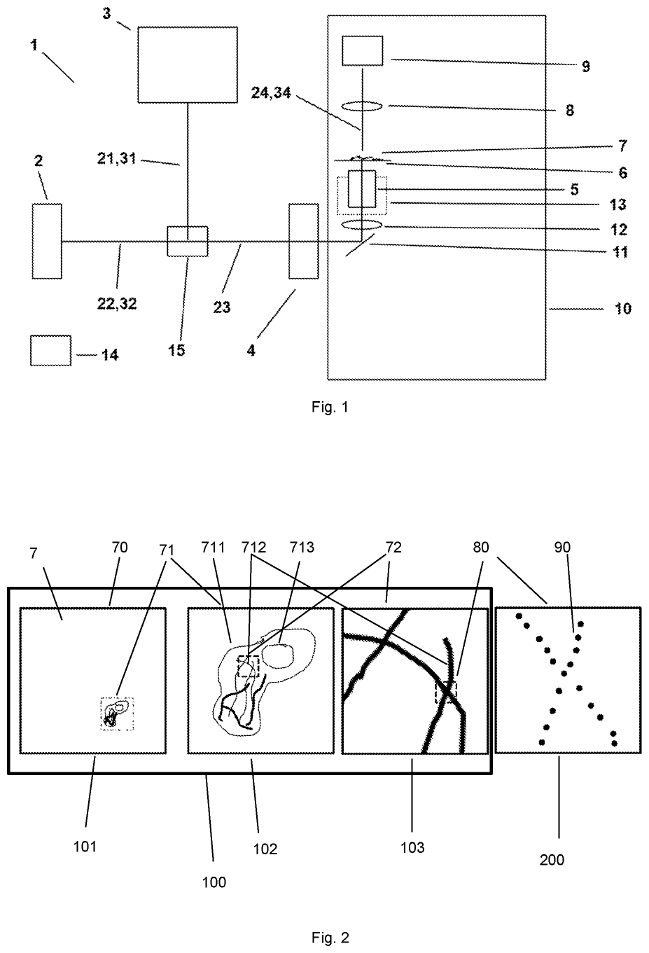

The microscope 1 according to the invention shown in FIG. 1 comprises a confocally arranged detection unit 2, which has an adjustable wavelength range and is set up to detect light of a continuous wavelength range at each selected setting. It further comprises a light source unit 3. This light source unit 3 comprises an excitation laser and a unit for modulating the wavefront of the excitation light 31. The excitation light 31 is directed along an illumination light path 21 onto a dichroic element 15. By means of the dichroic element, the excitation light 31 is coupled into a portion of a light path forming a common light path 23 for the excitation light 31 and detection light 32. A deflection unit 4 is located in the common light path 23, which is designed here both to move the excitation light 31 in a scanning manner over a larger image field during a confocal microscopic image acquisition and to perform small scanning movements for carrying out a MINFLUX method. Using a deflection mirror 11, a tube lens 12, and an objective 5 held in an objective changing device 13, the excitation light 31 is focused into a sample 7 located on a sample carrier 6. When the excitation light 31 is suitable for exciting fluorescence in the sample 7, fluorescence excited in the sample 7 is guided to the dichroic element 15 as detection light 32 along the same common light path 23 in the reverse direction. The detection light 32 passes through the dichroic element 15, while any scattered excitation light 31 is prevented from passing through and is deflected toward the light source unit 3. The detection light 32 is directed along the detection light path 22 to and detected by the confocal detection unit 2. The microscope further comprises a control unit 14 which is arranged to perform a MINFLUX method. At the same time, it is set up here to perform a confocal image acquisition. It is also connected to the automatically controllable components of the microscope 1, such as the deflection unit, as well as to the detection unit 2 and to a further detector 9. Connected here means that signals can be sent between the control unit 14 and the connected components and the detectors in at least one direction, for example via radio or via a cable connection. The microscope 1 further comprises a stand 10, which in particular supports or contains the tube lens 12, the objective 5 and the sample carrier 6. Detachably attached to the stand 10 is the further detector 9. This detector 9 detects light 34 transmitted through the sample 7, which is directed along a transmitted light detection light path 24 through a condenser 8 onto it.

FIG. 2 schematically illustrates the sequence of a method according to the invention. In the example shown, the first acquisition 100 comprises three substeps 101, 102, 13. A sample 7, which here completely fills a total area 70, is imaged with a substep 101 of the first acquisition in order to find and possibly identify objects to be examined. A scanning contrast method may be used in the sub-step 101. A lens 5 with a low magnification, for example 10×, is selected for the illumination, which ensures that the scanning unit 4 can completely scan the total area 70. Detection can be performed using the detector 9 shown in FIG. 1. Using not shown optical components in the optical path 21, 23 in illumination direction in front of the scanning unit 4, i.e., in such a way that the illumination light first reaches the components and then the scanning unit 4, and in the transmitted light detection light path 24, differential interference contrast can be used as contrast method. Before switching to a fluorescence microscopic imaging method, these components, which are not shown, are at least removed from the detection light path 22 including the common light path 23, for example, swung out by a motor. In the overall area 70, an object is found in a partial area 71. This sub-area 71 is now scanned and imaged in a second sub-step 102 using a lens 5 with a higher magnification, for example 100×. For this, the same or a different imaging method can be used as in the first step. Preferably, a method is selected which puts as little stress as possible on the sample 7. In the partial area 71 there is a cell with a cell membrane 711, organelles 712 (thinly drawn lines) and further organelles (drawn thicker, for a better overview without reference number) and a cell nucleus 713. The observer now selects a partial area 72 within the cell which contains organelles 712. This sub-region is now imaged using a high-resolution, scanning technique, for example, confocal microscopic imaging or STED imaging. In the obtained image, a sample region of interest 80 is determined. This sample region of interest 80 is chosen here so that both the measurements to determine wavelength ranges for optimized ratiometric separation of the multiple dyes and the localization 200 of the fluorophores themselves are performed within it.

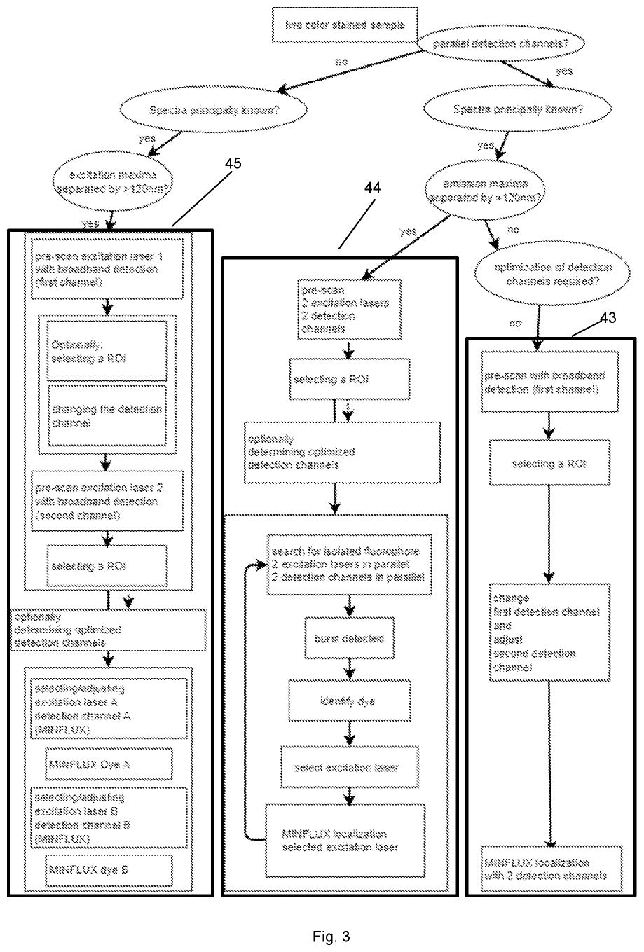

FIG. 3 shows flowcharts of the fifth method 45, the fourth method 44 and the third method 43. In addition, a decision tree is shown above, from which it can be seen under which conditions the respective method should preferably be used. For example, the left method is used in particular if the microscope does not have parallel, suitable detection channels, but if it has only exactly one suitable detection unit. If the spectral properties of the two dyes contained in the sample 7 are known in principle and the absorption maxima for separation of the dyes are far enough apart, for example more than 120 nm, due to the choice of different excitation wavelengths, then the fifth method 45 can advantageously be used. In the flow chart, steps to be performed in chronological order are now indicated by a directed arrow. If steps are shown one below the other within a box, but are not connected, the sequence is not fixed. An exception to this is the information on the fifth method 45 with regard to selecting and setting the excitation lasers and performing the MINFLUX localization. Here, it is self-evident that with settings for a dye A, MINFLUX localizations of dye A are performed, and the same applies accordingly for dye B. The flow chart is self-explanatory against the background of this reference and the corresponding explanations for the fifth method in the description of the invention.

If, on the other hand, the microscope 1 comprises parallel suitable detection channels and if the spectral properties of the two dyes contained in the sample 7 are known in principle and if the absorption maxima for separation of the dyes are far enough apart, for example more than 120 nm, due to the choice of different excitation wavelengths, then the fourth method 44 can advantageously be used. The flow chart is self-explanatory against the background of the corresponding explanations for the fifth method in the description of the invention.

In the case that wavelength ranges for an optimized ratiometric separation of the multiple dyes are already very well known in advance, for example because they have been determined beforehand on a reference sample according to a method according to the invention, the one objective to be solved is to perform an overall imaging as photon efficient as possible, which in the image provides a highly accurate embedding of the range recorded by means of a MINFLUX method into the image range obtained in the course of the first acquisition 100. In particular, in the case where the absorption spectra of the multiple dyes used are too similar for separation by using different excitation wavelengths, this task is solved by the third method. A prescan is performed with broadband detection in a first detection channel, further a sample region of interest is determined. Typically, the user will first determine the sample area 80 of interest before initiating the setting of the two detection channels to be used subsequently. That is why the corresponding steps are connected here by a directed arrow. In fact, however, the sequence can be interchanged. After the first detection channel is changed and the second detection channel is set, a MINFLUX localization is performed using two detection channels. The fluorophores 90 are separated ratiometrically. In principle, it is also conceivable to perform detection during prescan with a detection unit that is not used for MINFLUX localization. However, this not only requires an additional detection unit, but also increases the adjustment effort. If the detection is performed with a cascaded detection unit, in particular one as known from patent DE 10 2018 126 232 B3, it is preferred to perform the detection with the first detection unit during the prescan. Further detectors are only reached by light with wavelengths which are not directed to this first detection unit. Consequently, for a detection in two channels, which often overlap at least with the first wide detection channel, the first detection channel must be changed.

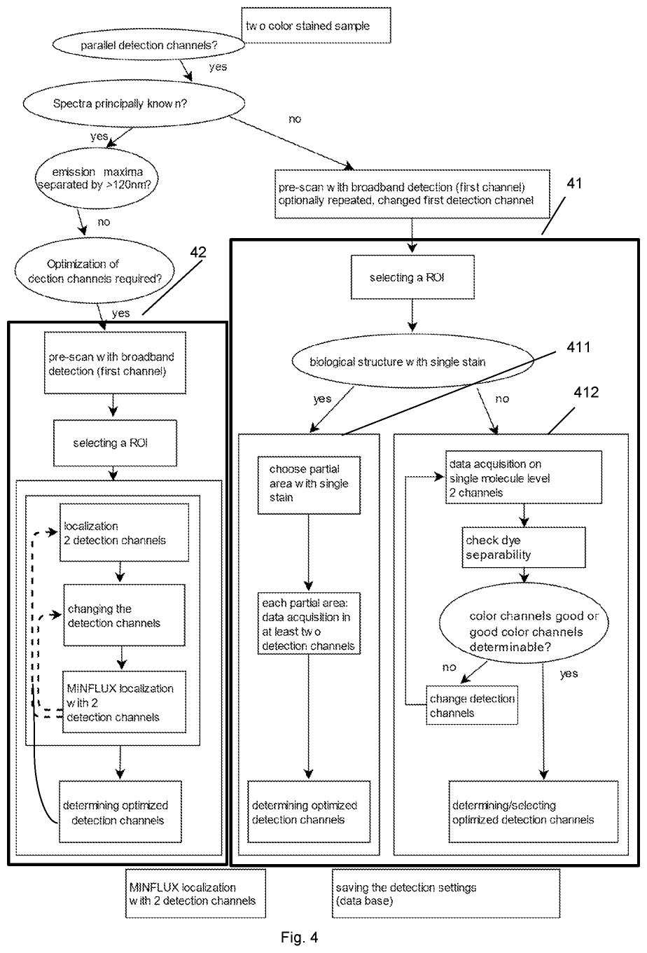

FIG. 4 shows flowcharts of embodiments of the second method 42 and the first method 41. These flowcharts are also largely self-explanatory against the background of the corresponding explanations of the relevant methods 41, 42 in the description of the invention. However, it should be explained here what is indicated by the two dashed arrows and the line connected thereto within the frame symbolizing the second method 42. Between different steps of localization in multiple detection channels, the detection channels are changed. On the one hand, this can be done to find optimized settings by comparing the quality of the ratiometric separation. However, it can also happen when it is recognized from the data that the settings need to be changed for optimized separation. In this case, therefore, a determination of optimized or at least improved detection channels is first made before the settings are changed. Further it should be noted that the first localization, which is used at the same time to find improved or optimized detection channels, can also be a method like PALM. In principle, this also applies to the following localizations. However, molecular resolution can only be achieved with such methods under very favorable conditions at best. Therefore, it is strongly preferred to use a MINFLUX or a STED-MINFLUX method.

### LIST OF REFERENCE NUMERALS

1 Microscope
2 Detection device or detection unit
3 Light source unit
4 Scanning unit
5 Objective
6 Sample carrier
7 Sample
8 Condenser
9 Detector
10 Stage
11 Deflection mirror
12 Tube lens
13 Objective changing device
14 Control unit
15 Dichroic element
21 Illumination light path
22 Detection light path
23 Common light path
24 Transmitted light detection light path
31 Excitation light
32 Detection light
34 Transmitted light
41 First method
42 Second method
43 Third method
44 Fourth method
45 Fifth method
70 Total area
71 Subsection
72 Subsection
80 Sample region of interest
90 Fluorophores
100 First acquisition
101 Substep
102 Substep
103 Substep
200 Localize
411 First further development
412 Second further development
711 Cell membrane
712 Organelle
713 Nucleus

1.-39. (canceled)

40. Method for localization microscopic examination of a sample stained with multiple dyes comprising:
a first acquisition of image data of the sample or a partial area of the sample,
determining and selecting a sample region of interest based on the image data,
exciting fluorophores in a first subregion within the selected sample region of interest with excitation light of a first excitation wavelength, and a first detection of the fluorescence photons emitted by the excited fluorophores in a first wavelength range with a first detection unit,
a second detection of the fluorescence photons emitted by fluorophores excited with excitation light of the first excitation wavelength in a second wavelength range different from the first wavelength range with a detection unit or the detection unit, wherein the first detection unit is configured such that the wavelength range in which it detects fluorescence photons is adjustable, wherein the method further comprises:
a determination of wavelength ranges for an optimized ratiometric separation of the multiple dyes in a localization microscopic image acquisition of the sample in multiple spectral detection channels, wherein localization or tracking of isolated fluorophores is performed in the sample region of interest according to a MINFLUX method or a STED-MINFLUX method, wherein the detection of the fluorescence photons is performed respectively in the wavelength ranges determined for optimized ratiometric separation of the plurality of dyes.

41. The method according to claim 40, wherein the first subregion within the sample region of interest is selected based on the image data such that only or substantially only fluorophores of a first dye are contained therein, and wherein a plurality of fluorophores in the first subregion are excited with excitation light of the first excitation wavelength, and wherein a first and a second value characterizing the spectral emission of the first dye are obtained from the first and second detections.

42. The method according to claim 41, wherein a second subregion and optionally further subregions within the sample region of interest is or are selected based on the image data in such a way that in it or in each of them exclusively or substantially only fluorophores of a second or a further dye are contained and that in the second or respectively in a further sub-area a plurality of fluorophores is excited with excitation light of the first excitation wavelength and wherein detection of the fluorescence photons emitted by the respective excited fluorophores takes place in the first and the second wavelength range, and wherein in each case a first and a second value characterizing the spectral emission of the second or of the respective further dye are obtained.

43. The method according to claim 41, wherein a further detection of the fluorescence photons emitted by fluorophores of the first, of the second or of one dye of the further dyes respectively excited with excitation light of the first excitation wavelength takes place in one or more further wavelength ranges, different from each other and from the first and second wavelength ranges, so that a plurality of values characterizing the spectral emission of the first, the second or one of the further dyes is obtained from the measurement on the sample stained with multiple dyes.

44. The method according to claim 41, wherein the alternately different wavelength ranges do not overlap.

45. The method according to claim 42, wherein the wavelength ranges for an optimized ratiometric separation are obtained from the respective first and second values characterizing the spectral emission of the first or the second or optionally of a further dye or from the plurality of such values.

46. The method according to claim 41, wherein the first detection unit is used for detection in different wavelength ranges.

47. The method according to claim 40, wherein the first subregion within the sample region of interest is selected based on the image data to include fluorophores of multiple dyes, and wherein isolated fluorophores are repeatedly excited in the first subregion, wherein a total of fluorophores of all of the multiple dyes are excited.

48. The method according to claim 47, wherein a further excitation of fluorophores with excitation light of the first excitation wavelength and a further detection in two further wavelength ranges is performed, wherein at least one of the two further wavelength ranges is neither the first nor the second wavelength range.

49. The method according to claim 47, wherein the first wavelength range and the second wavelength range are adjacent to each other at a first threshold wavelength.

50. The method according to claim 47, wherein the two further wavelength ranges are adjacent to each other at one or the threshold wavelength or a further threshold wavelength.

51. The method according to claim 50, wherein a further excitation and detection is carried out several times, with a different further threshold wavelength being selected in each case.

52. The method according to claim 47, wherein the first wavelength range and/or one of the further wavelength ranges comprises wavelengths that are smaller than the first excitation wavelength.

53. The method according to claim 47, wherein an assignment of fluorescence photons detected in each case during the detection in two wavelength ranges, in the first and the second wavelength range and/or in one and another wavelength range of the two further wavelength ranges, to bursts of the isolated fluorophores is carried out, and wherein the numbers of the fluorescence photons detected in the one and the other wavelength range are determined for the bursts in each case.

54. The method according to claim 53, wherein the wavelength ranges for optimized ratiometric separation are determined from the numbers of fluorescence photons detected in the one and the other wavelength range determined for the bursts.

55. The method according to claim 40, wherein the first acquisition of image data comprises an acquisition step comprising a scanning of the sample, the scanning being performed by applying a first deflection unit in the optical path of the excitation light.

56. The method according to claim 55, wherein the scanning comprises confocal scanning or joint scanning with focused excitation and fluorescence inhibition light.

57. The method according to claim 56, wherein the detection in the confocal scanning or the joint scanning with focused excitation and fluorescence inhibition light is performed in a contiguous wavelength range and not spectrally resolved.

58. A method for localization microscopic examination of a sample stained with multiple dyes comprising:
a first acquisition of image data of the sample or a partial area of the sample,
determining and selecting a sample region of interest based on the image data such that fluorophores of multiple dyes are contained in the sample region of interest,
localizing isolated fluorophores of the multiple dyes according to a MINFLUX method, wherein an excitation with excitation light of a first excitation wavelength is performed, and wherein a detection of the fluorescence photons is respectively performed in a first and a second wavelength range different from the first wavelength range,
wherein the method further comprises:
localizing the isolated fluorophores of the multiple dyes according to a MINFLUX method or a STED-MINFLUX method, wherein the detection of the fluorescence photons is respectively performed in two further wavelength ranges, wherein at least one of the two further wavelength ranges does not coincide with either the first or the second wavelength range.

59. The method according to claim 58, wherein the first and the second wavelength regions are contiguous at a first threshold wavelength.

60. The method according to claim 59, wherein the two further wavelength ranges adjoin each other at a further threshold wavelength which does not coincide with the first threshold wavelength.

61. The method according to claim 58, wherein the first wavelength range and/or one of the further wavelength ranges comprises wavelengths that are smaller than the first excitation wavelength.

62. A method for localization microscopic examination of a sample stained with multiple dyes comprising:
a first acquisition of image data of the sample or a partial area of the sample,
determining and selecting a sample region of interest based on the image data such that fluorophores of multiple dyes are contained in the sample region of interest,
localizing isolated fluorophores of the multiple dyes according to a MINFLUX method or a STED-MINFLUX method, wherein excitation with excitation light of a first excitation wavelength is performed, and wherein detection of the fluorescence photons is respectively performed in a first and a second wavelength range different from the first wavelength range,
wherein the first acquisition of image data of the sample or the partial region of the sample is performed by confocal scanning or joint scanning with focused excitation and fluorescence inhibition light, wherein the detection is performed in a continuous wavelength range and not spectrally resolved.

63. The method according to claim 62, wherein the contiguous wavelength range comprises the first wavelength range and the second wavelength range.

64. A method for localization microscopic examination of a sample stained with multiple dyes comprising:
a first acquisition of image data of the sample or a partial area of the sample,
determining and selecting a sample region of interest based on the image data such that fluorophores of multiple dyes are contained in the sample region of interest,
localizing an isolated fluorophore of the multiple dyes by a MINFLUX method or a STED-MINFLUX method,
wherein the method further comprises:
prior to localizing by the MINFLUX method or the STED-MINFLUX method: an illumination or a first illumination of the isolated fluorophore or the isolated fluorophores with excitation light of a first excitation wavelength and a second excitation wavelength, thereby exciting the isolated fluorophore or fluorophores to fluoresce,
detecting fluorescent photons emitted from the excited fluorophore or fluorophores in a first and a second wavelength range different from the first wavelength range; and
selecting an excitation wavelength or excitation wavelengths at which the isolated fluorophore or isolated fluorophores is or are excited to fluoresce for localization by the MINFLUX method or the STED-MINFLUX method.

65. The method according to claim 64, wherein the first illumination of the isolated fluorophore is performed in a first subregion within the selected sample region of interest, wherein a first and a second detection value are obtained from the fluorescence photons detected in the first wavelength region and the second wavelength region, and wherein the localizing is performed using excitation light of the selected excitation wavelength as the only excitation light.

66. The method according to claim 64, wherein the first acquisition of image data is carried out by
i) a confocal scanning of the sample or the partial region of the sample with focused excitation light of the first excitation wavelength or by a joint scanning with focused excitation light of the first excitation wavelength and fluorescence inhibition light, and detecting the fluorescence photons emitted by the excited fluorophores in the first wavelength region with a detection unit, and
ii) by subsequent confocal scanning of the sample or of the partial region of the sample with focused excitation light of a second excitation wavelength or by joint scanning with focused excitation light of the second excitation wavelength and fluorescence inhibition light, and detection of the fluorescence photons emitted by the excited fluorophores in a second wavelength range, which does not coincide with the first wavelength range, is carried out with the detection unit, wherein the first and the second wavelength range are in each case contiguous, and wherein the detection in the first and the second wavelength range is in each case carried out in a non-spectrally resolved manner, and wherein the detection unit is appropriately adjusted for the respective detection, and wherein
in the localization of the isolated fluorophores of the first dye, excitation light of the first excitation wavelength is used for the excitation of the isolated fluorophores, and the fluorescence photons emitted by the excited isolated fluorophores are detected with the detection unit in a third wavelength range, and wherein
in the localization of the isolated fluorophores of the second dye, excitation light of the second excitation wavelength is used for the excitation of the isolated fluorophores, and the fluorescence photons emitted by the excited isolated fluorophores are detected with the detection unit in a fourth wavelength range.

67. The method according to claim 66, characterized in that wherein the third and the first wavelength ranges are identical and/or that the fourth and the second wavelength ranges are identical.

68. The method according to claim 66, characterized in that wherein the third and/or the fourth wavelength range are determined based on an analysis of the image data obtained during the first acquisition of image data such that when localizing the isolated fluorophores of the first and/or the second dye according to a MINFLUX method or a STED-MINFLUX method, the interfering background fluorescence is minimized.

69. A microscope for carrying out a method according to claim 40.
